(19) United States
(12) Patent Application Publication
(10) Pub. No.: US 2016/0212463 A1
(43) Pub. Date: Jul. 21, 2016

(54) METHOD FOR REALIZING A PPV PURCHASE MECHANISM

(71) Applicant: SK Planet Co., Ltd., Gyeonggi-do (KR)

(72) Inventors: Jong Ho KIM, Seoul (KR); Do Wan KIM, Gyeonggi-do (KR); Chang Il KIM, Seoul (KR); Jin Seung CHOI, Seoul (KR); Min Seok KIM, Gyeonggi-do (KR); Sang Yun LEE, Gyeonggi-do (KR)

(73) Assignee: SK Planet Co., Ltd., Gyeonggi-do (KR)

(21) Appl. No.: 14/979,057

(22) Filed: Dec. 22, 2015

Related U.S. Application Data
(62) Division of application No. 12/520,922, filed on Jun. 23, 2009, now abandoned.

(30) Foreign Application Priority Data
Dec. 26, 2006 (KR) 10-2006-0134044

(51) Int. Cl. H04N 21/2543; H04N 21/235; H04N 21/266; H04N 21/418; H04N 21/434; H04N 21/472; H04N 21/2347; H04N 21/237; H04N 21/2362; H04N 21/4623

(52) U.S. Cl. CPC H04N 21/25435; H04N 21/2362; H04N 21/2353; H04N 21/26606; H04N 21/4623; H04N 21/4345; H04N 21/47211; H04N 21/2347; H04N 21/237; H04N 21/4181

(57) ABSTRACT

Disclosed is a method and a system for realizing a Pay Per View (PPV) purchasing mechanism. The system includes: a broadcasting center for setting system information including an available purchase time, an available purchase cancellation time, and a time point for transfer of PPV details regarding each PPV broadcast program, for broadcasting the PPV broadcast programs and the system information to a broadcasting network, and for performing charging of a price and a management of a viewing right through provided PPV details information on each PPV broadcast program; and a broadcast viewing terminal for booting a previously set PPV purchase application on the basis of the PPV broadcast programs and the system information, for receiving PPV broadcast programs and system information provided through a broadcasting network, for purchasing or canceling the purchase of a prescribed PPV broadcast program at the available purchase time or at the available purchase cancellation time on the basis of PPV details information previously stored in the broadcast viewing terminal, for forming PPV details information updated according to a result of processing a broadcast viewing right by discriminating if the PPV broadcast program is rebroadcasted, and for delivering the updated PPV details information to the broadcasting center via a mobile communication network or an internet. Hence, details information formed by purchase and purchase cancellation regarding the PPV broadcasting programs can be flexibly employed, and by discriminating if a PPV broadcast program received through a broadcast viewing terminal is rebroadcasted, setting a discriminative broadcast viewing right and handling the charging of price can be performed.

### BACKGROUND OF THE INVENTION

1. Field of the Invention

The present invention relates to providing a Pay Per View (PPV) scheme in a mobile broadcast environment, and more particularly to a method and a system for realizing a series of PPV purchasing mechanisms, including purchase and purchase cancellation regarding each PPV broadcast program, discrimination between an original broadcast and a rebroadcast, and repurchase following the cancellation of purchase.

2. Description of the Prior Art

Conventionally, the terms, which include multichannel, high quality, and multifunction, summarize the features of digital broadcasting. In particular, with the development of multiplexing technology, images, voices, data, and the like, being combined into one signal, can be simultaneously transferred irrespective of their contents and sizes, and as a return channel through a MOdulator-DEModulator (MODEM) is formed, an interactive service is enabled. Accordingly, digital data broadcasting overcomes the limits of the existing analog broadcasting, and can then provide viewers with higher value-added multimedia services. However, in integrated broadcasting of digital data, if a mutual security property between the transmit (Tx) side and the receive (Rx) side is not established, a commercial structure of broadcasting collapses. In addition, with the activation of multichannel and specialized channels, broadcasters break away from services which have depended on the existing advertising revenue, and as they provide subscribers with good broadcasting services in quality, intend to provide pay broadcasting services which collect television subscription fee from the subscribers. Also, the broadcasters hope that as various transmitted multimedia data is protected, only authentic subscribers who have legitimate receive (Rx) rights will receive the transmitted multimedia data. In response to the demand for solving these problems, a Conditional Access System (CAS) has been developed.

The CAS corresponds to a system in which the introduction of the concept of “subscriber” in broadcasting enables only a subscriber who has a legitimate viewing right to receive a particular program, and signifies a chain of processes where digital broadcasting receiver determines if a recipient can receive any specific broadcast program. The CAS corresponds to a system which enables a transmitter to transfer an encoded program signal and an Rx entitlement (i.e., Rx qualification) granted to each recipient or a particular group, and at the Rx side, enables only a subscriber who obtains Rx authorization to decipher a code by using a smart card equipped to a receiver so as to receive a program.

Furthermore, the digital data broadcasting corresponds to a mobile multimedia broadcasting service in which broadcasting and communication are combined together, and is called Digital Multimedia Broadcasting (DMB), which provides a Compact Disc (CD) level of sound quality and data and a high-quality moving picture service through a mobile communication terminal, a Personal Digital Assistant (PDA), a terminal for a vehicle, and others.

Meanwhile, the digital multimedia broadcasting services are mostly supposed to be provided as pay services, and accordingly enable each subscriber to purchase either a movie, a program, or a one-time event on a basis of one commodity, and provide PPV services, each of which corresponds to a broadcasting service employing the price-rate system in which an amount is charged corresponding to how often a viewer views programs. Namely, the PPV service, which is different from a scheme in which an amount of money is charged beforehand for a set amount of time during which the user is allowed to view programs, corresponds to a scheme in which price is charged per view with respect to a specific program that a user desires, and is classified into a scheme where a prepaid price is charged and a scheme where price to be paid later is charged.

However, with the prior PPV service like this, problems are raised, in that details of purchase and purchase cancellation regarding each PPV broadcast program through a broadcast viewing terminal of each viewer are not systematically managed, and accordingly, information included in data transferred so as to form a charged price is not employed flexibly. Hence, to solve these problems is needed.

### SUMMARY OF THE INVENTION

Accordingly, the present invention has been made to solve the above-stated problems occurring in the prior art, and it is an object of the present invention to provide a method and a system for realizing a series of Pay Per View (PPV) purchasing mechanisms, in which each PPV broadcast program and system information corresponding to each PPV broadcast program are realized according to a special transmission standard, details information formed by purchase and purchase cancellation regarding the PPV broadcasting programs on the basis of the above realization is flexibly employed, and by discriminating if a PPV broadcast program selected through details information updated in a terminal is rebroadcasted, a discriminative broadcast viewing right is granted.

Also, in order to implement a method and a system for realizing a PPV purchasing mechanism according to the present invention, the present invention provides: a broadcasting center for setting system information on PPV broadcast programs, setting the PPV broadcast programs and the system information, and then broadcasting the PPV broadcast programs and the system information to a broadcasting network, and for performing charging prices and the management of viewing rights through PPV details information provided from a broadcast viewing terminal for receiving the broadcasted PPV broadcast programs and the system information; and a broadcast viewing terminal for receiving PPV broadcast programs and system information provided through a broadcasting network, for purchasing or canceling the purchase of a prescribed PPV broadcast program at an available purchase time or at an available purchase cancellation time on the basis of previously stored PPV details information, for processing a broadcast viewing right by discriminating if each PPV broadcast program is rebroadcasted, and having the capability of delivering PPV details information updated in relation to a PPV service to the broadcasting center via a mobile communication network or the internet.

In accordance with a first aspect of the present invention for attaining the above objects, there is provided a method for realizing a PPV purchasing mechanism, including the steps of: setting system information including an available purchase time, an available purchase cancellation time, and a time point for transfer of PPV details regarding each PPV broadcast program, scrambling the PPV broadcast program and the system information, and then broadcasting the scrambled PPV broadcast program and system information to a broadcasting network, by a broadcasting center; receiving the PPV broadcast program and the system information, and booting a previously set PPV purchase application, by a broadcast viewing terminal; purchasing a prescribed broadcast program on the basis of previously stored PPV details information and list information on the PPV broadcast programs at the available purchase time and then forming purchase details, and processing a broadcast viewing right; forming purchase cancellation details on the basis of updated PPV details information at the available purchase cancellation time, or reaching the time point for transfer of PPV details and then sending the PPV details information to a mobile communication network or an internet; and setting a viewing right and a discount rate in regard to each subscriber on the basis of the PPV details information, and charging a price, by the broadcasting center.

In accordance with a second aspect of the present invention for attaining the above objects, there is provided a method for realizing a PPV purchasing mechanism, including the steps of: receiving PPV broadcast programs and system information, and reading an event IDentification (ID) according to each PPV broadcast program included in a descriptor of Program Specific Information (PSI) and Service Information (SI) of the system information, and a PPV event ID according to each PPV broadcast program set as an additional data byte in the descriptor of the PSI and SI, by a broadcast viewing terminal; discriminating if each PPV broadcast program is rebroadcasted through the event ID and the PPV event ID, and performing a purchase and a purchase cancellation of a prescribed PPV broadcast program on the basis of a result of the discrimination; forming PPV details information on a case where the PPV broadcast program corresponds to a rebroadcast, and processing a relevant broadcast viewing right; and receiving the PPV details information provided through a mobile communication network or an internet, and performing the charging of a price, distinguished from the original broadcast, by a broadcasting center.

In accordance with a third aspect of the present invention for attaining the above objects, there is provided a method for realizing a PPV purchasing mechanism, including the steps of: receiving, from a broadcast viewing terminal, PPV details information setting purchase and purchase cancellation details on the basis of an event ID and a PPV event ID in regard to each PPV broadcast program, and then executing a count setting required to limit a corresponding purchase, a corresponding purchase cancellation, and a corresponding repurchase of each PPV broadcast program with respect to the broadcast viewing terminal, by a broadcasting center; and performing counting in regard to a purchase and a purchase cancellation of each PPV broadcast program on the basis of provided limit count information, and then setting, in a limited manner, a purchase, a purchase cancellation, and a repurchase of a relevant PPV broadcast program, by the broadcast viewing terminal.

In accordance with a fourth aspect of the present invention for attaining the above object, there is provided a method for realizing a PPV purchasing mechanism, including the steps of: updating, by a broadcast viewing terminal, previously stored PPV details information by using purchase details regarding a prescribed PPV broadcast program on the basis of received PPV broadcast programs and system information; and deleting, by the broadcast viewing terminal, relevant purchase details from the PPV details information if a cancellation of the purchase in regard to the purchase details is performed.

In accordance with a fifth aspect of the present invention for attaining the above objects, there is provided a system for realizing a PPV purchasing mechanism, including: a broadcasting center for setting system information including an available purchase time, an available purchase cancellation time, and a time point for transfer of PPV details regarding each PPV broadcast program, for broadcasting the PPV broadcast programs and the system information to a broadcasting network, and for performing charging of a price and a management of a viewing right through provided PPV details information on each PPV broadcast program; and a broadcast viewing terminal for booting a previously set PPV purchase application on the basis of the PPV broadcast programs and the system information, for receiving PPV broadcast programs and system information provided through a broadcasting network, for purchasing or canceling the purchase of a prescribed PPV broadcast program at the available purchase time or at the available purchase cancellation time on the basis of PPV details information previously stored in the broadcast viewing terminal, for forming PPV details information updated according to a result of processing a broadcast viewing right by discriminating if the. PPV broadcast program is rebroadcasted, and for delivering the updated PPV details information to the broadcasting center via a mobile communication network or an internet.

### BRIEF DESCRIPTION OF THE DRAWINGS

The above and other exemplary features, aspects, and advantages of the present invention will be more apparent from the following detailed description taken in conjunction with the accompanying drawings, in which:

FIG. 1 is a block diagram illustrating the configuration of a PPV purchasing mechanism system according to an embodiment of the present invention; and

FIG. 2 is a flowchart showing an operation process of the system illustrated in FIG. 1.

### DETAILED DESCRIPTION OF THE EXEMPLARY EMBODIMENTS

Hereinafter, exemplary embodiments of a Pay Per View (PPV) purchasing mechanism system according to the present invention will be described in detail with reference to the accompanying drawings. In the following description of the present invention, a detailed description of known functions and configurations incorporated herein will be omitted when it may make the subject matter of the present invention rather unclear.

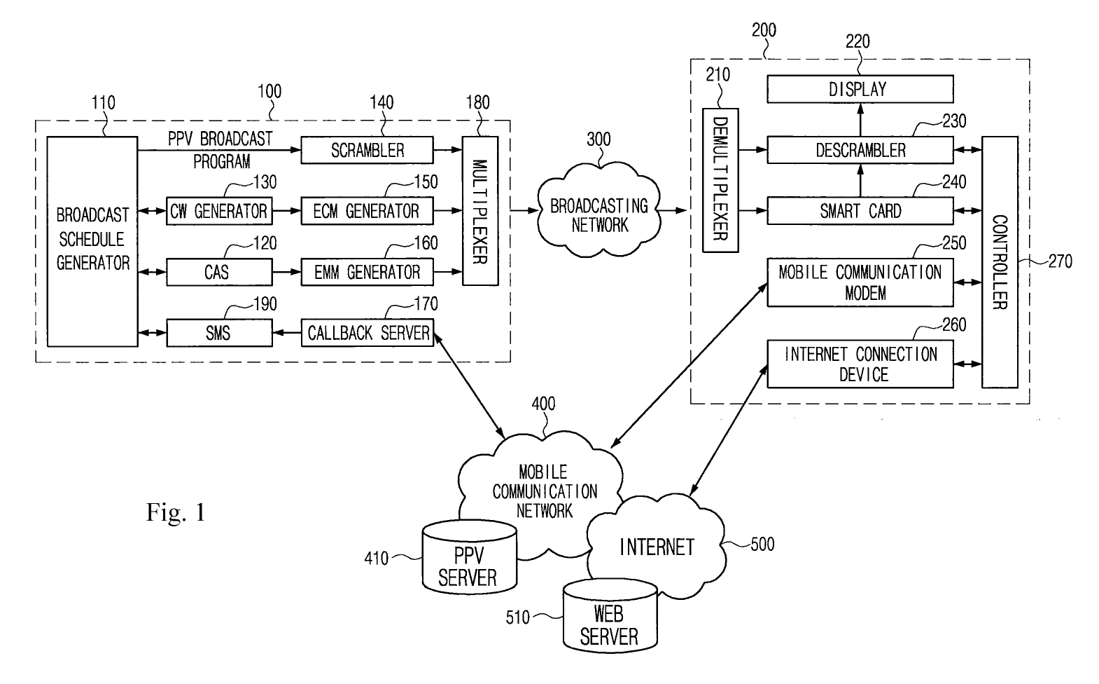

FIG. 1 is a block diagram illustrating the configuration of a PPV purchasing mechanism system according to an embodiment of the present invention. As illustrated in FIG. 1, the PPV purchasing mechanism system is configured to include a broadcasting center 100, a broadcasting network 300, each broadcast viewing terminal 200, a mobile communication network 400, and an internet 500.

The broadcasting center 100 is connected to various program providers, and performs a process for implementing a PPV service in regard to provided broadcast programs. In this process, the broadcasting center 100 sets system information, including an available purchase time, an available purchase cancellation time, and a time point for transfer of PPV details regarding each PPV broadcast program according to a broadcast schedule required to send programs through the broadcasting network 300, and broadcasts the system information, set in this manner, and the PPV broadcast programs to the broadcasting network 300 according to a schedule.

Also, based on PPV broadcast programs and system information received through the broadcasting network 300, the broadcast viewing terminal 200 boots a previously set PPV purchase application, purchases or cancels the purchase of a prescribed PPV broadcast program at an available purchase time or at an available purchase cancellation time on the basis of PPV details information previously stored in the terminal, and discriminates if each PPV broadcast program is rebroadcasted, thereby processing a broadcast viewing right (or an entitlement). Furthermore, the broadcast viewing terminal 200 delivers PPV details information formed through logics, such as purchase and purchase cancellation (i.e., the cancellation of purchase), whether or not it is rebroadcasted, repurchase, and the like, to the broadcasting center 100 via the mobile communication network 400 or the internet 500.

Accordingly, if the PPV details information is sent through a mobile communication MODEM 250 equipped with the broadcast viewing terminal 200 with the mobile communication network 400 as a path, a PPV server 410 equipped to the mobile communication network 400, being connected to the broadcast viewing terminal 200 in the manner of web, is provided with updated PPV details information, and then delivers the provided PPV details information to a callback server 170 of the broadcasting center 100 connected via a network.

Meanwhile, if the broadcast viewing terminal 200 sends PPV details information through an equipped Internet connection device 260 with the internet 500 as a path, a relevant web server 510 of the internet 500 is provided with the PPV details information, and then delivers the received PPV details information to the PPV server 410, or can directly deliver the PPV details information to the callback server 170 as being directly connected to the callback server 170 of the broadcasting center 100 in the manner of web.

The broadcasting center 100 enables a Subscriber Management System (SMS) 190 to process the PPV details information of the broadcast viewing terminal 200 delivered through the callback server 170, and then provides a PPV service corresponding to each broadcast viewing terminal 200.

Furthermore, to examine an internal configuration in relation to the broadcasting center 100, the broadcasting center 100 is configured to include a broadcast schedule generator 110, a subscriber management system 190, a Conditional Access System (CAS) 120, a Control Word (CW) generator 130, a scrambler 140, an Entitlement Control Message (ECM) generator 150, an Entitlement Management Message (EMM) generator 160, a callback server 170, and a multiplexer 180. Herein, the broadcast schedule generator 110 executes PPV service linkage in regard to broadcast programs provided from various program providers, and generates a broadcast schedule of each PPV broadcast program. The subscriber management system 190 manages the PPV service. The CAS 120 executes broadcast viewing right (or entitlement) management, processing the charging of prices, and the like. The CW generator 130 produces various CWs (i.e., control information), such as the scrambling of PPV broadcast programs, and others. The scrambler 140 scrambles PPV broadcast programs on the basis of a relevant schedule through the CW. The ECM generator 150 includes, in an ECM, a CW received from the CW generator 130, and information on Rx qualification by each channel and on Rx qualification by each program, produces the ECM corresponding to a message used to protect a broadcast program, and then outputs the ECM. The EMM generator 160 is linked (or interlocked) with the CAS 120 taking charge of right (or entitlement) management by each subscriber, includes, in an EMM, an encryption key of an ECM and information on viewing right by each subscriber, and then produces the EMM used to authenticate a subscriber. The multiplexer 180 multiplexes output signals of the scrambler 140, the ECM generator 150, and the EMM generator 160, and then broadcasts a multiplexed signal to the broadcasting network 300.

Also, an internal configuration of the broadcast viewing terminal 200 includes a demultiplexer 210, a descrambler 230, a display 220, a smart card 240, a controller 270, a mobile communication MODEM 250, and an internet connection device 260. Herein, the demultiplexer 210 receives PPV broadcast programs and system information broadcasted through the broadcasting network 300, and then decodes the received PPV broadcast programs and system information. The descrambler 230 discriminates between scrambled PPV broadcast programs. The display 220 activates descrambled PPV broadcast programs on a terminal screen. The smart card 240 stores a previously set PPV purchase application, and stores PPV application details information formed through the booting of the PPV purchase application. The controller 270 provides a guide menu to each user after booting the PPV purchase application, and then executes purchase, the cancellation of purchase, and then executes, in response to an input signal, purchase and purchase cancellation of PPV broadcast programs, and discriminating if each PPV broadcast program is rebroadcasted. The mobile communication MODEM 250 transfers PPV details information stored in the smart card 240 through the mobile communication network 400 according to a command signal of the controller 270. The internet connection device 260 transfers the PPV details information through the internet 500.

Additionally, in the broadcast viewing terminal 200, a memory in which PPV details information is stored can be embodied by using a NonVolatile Random Access Memory maw or a Secure Digital (SD) card, besides a smart card 240.

Hereinafter, an operation process of the system for realizing a PPV purchasing mechanism according to the present invention will be described in further detail with reference to the accompanying drawings as follows.

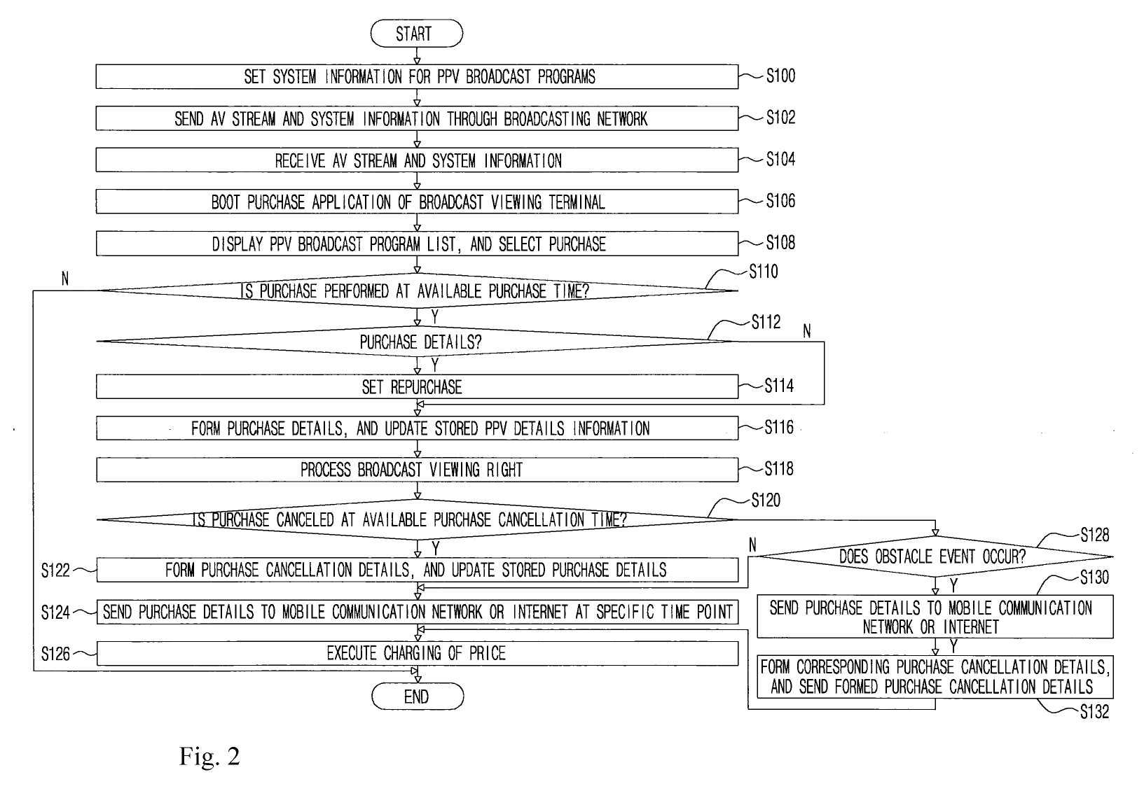

FIG. 2 is a flowchart showing an operation process of the system illustrated in FIG. 1. As illustrated in FIG. 2, in the method for realizing a PPV purchasing mechanism, a process (S100) is preceded by another process in which the broadcasting center 100 sets system information including an available purchase time, an available purchase cancellation time, and a time point for transfer of PPV details regarding each of PPV broadcast programs provided by various program providers. In step S100, broadcast preview time and an available purchase time are set in a descriptor of Program Specific Information (PSI) and Service Information (SI) of the system information, and a private data byte is set in the descriptor of the PSI and SI, thereby sending the available purchase cancellation time. At the same time, if the descriptor of the PSI and SI has no surplus necessary to set the private data byte in the descriptor thereof, it is also possible that information including the broadcast preview time, the available purchase time, the available purchase cancellation time, and the time point for transfer of PPV details are set for an ECM included in the system information, and then the set information is sent.

Also, realization can be attained in such a manner that both ECMS and EMMS are included in the system information, a key required to decode a CW included in the system information by the broadcast viewing terminal 200 is equipped to the ECM, and then the ECM is transferred to the broadcast viewing terminal 200 via the mobile communication network 400.

Through this process, the broadcasting center 100 scrambles the PPV broadcast programs and the system information, and then broadcasts the scrambled PPV broadcast programs and system information through the broadcasting network 300 (S102). Then, the PPV broadcast programs and the system information broadcasted via broadcasting network 300 are received by the broadcast viewing terminal 200 (S104). Thereafter, the broadcast viewing terminal 200 boots the PPV purchase application which has already been equipped to the broadcast viewing terminal 200 by a viewer's setting (S106). Accordingly, the viewer enables a process for setting a service to proceed through a guide menu displayed on a terminal screen, and then selects purchase regarding a prescribed broadcast program through a PPV broadcast program list displayed on the terminal screen (S108).

Following step S108, the procedure is switched to a process for purchasing the selected PPV broadcast program, and the viewer can purchase the selected broadcast program at an available purchase time set in the system information (S110). If purchase setting is executed in step S110, PPV details information which has already been stored in the broadcast viewing terminal is updated, and then the updated PPV details information reflects relevant purchase details (S112).

Furthermore, it is discriminated in step S110 whether or not the viewer has ever viewed the selected broadcast program through the broadcast viewing terminal 200, and then a process for forming an additional logic can be executed. In order to discriminate if the selected broadcast program corresponds to a rebroadcast, the broadcast viewing terminal 200 reads an event IDentification (ID) by each PPV broadcast program included in a descriptor of PSI and SI of the system received along with the PPV broadcast programs through the broadcasting network 300, and a PPV event ID by each PPV broadcast program which is set as an additional data byte in the descriptor of the PSI and SI and is then used to be distinguished from the event ID. Then, as the broadcast viewing terminal 200 compares read information with a program history included in the PPV details information previously stored in the broadcast viewing terminal 200, the broadcast viewing terminal 200 executes a process in which it is discriminated whether or not the relevant PPV broadcast program is rebroadcasted.

Meanwhile, if the PPV broadcast program for which purchase has been set in step S112 is already stored in the broadcast viewing terminal 200 as purchase cancellation details in the PPV details information, logic to a repurchase process is formed (S114). At the same time, a process for limiting purchase cancellation and repurchase can be executed additionally in this procedure. Namely, the broadcasting center 100 executes count setting required to limit purchase, purchase cancellation, and repurchase of each PPV broadcast program on the basis of the event ID and the PPV event ID in regard to each PPV broadcast program. Also, the broadcast viewing terminal 200 executes counting in regard to purchase and purchase cancellation of each PPV broadcast program on the basis of provided limit count information, and can then execute setting for limiting purchase, purchase cancellation, repurchase of a relevant PPV broadcast program. Therefore, if the broadcast viewing terminal 200 receives control information on the limit setting through an ECM, the broadcast viewing terminal 200 executes a PPV service in accordance with limits corresponding to the received control information.

Thereafter, a process is executed in which the broadcast viewing terminal 200 reflects formed purchase details and purchase cancellation details in previously stored PPV details information, and updates the stored PPV details information (S116), and then the procedure proceeds to broadcast viewing right processing which enables the viewer to view the relevant PPV broadcast program on the terminal screen (S118).

Also, the viewer can cancel purchase in regard to a PPV broadcast program purchased at an available purchase cancellation time, and accordingly, as stored purchase details corresponding to pertinent purchase cancellation details are deleted in response to PPV details information if the pertinent purchase cancellation details are formed, the stored purchase details corresponding to the pertinent purchase cancellation details are excluded from a transmission list (S120 and S122).

Through this process, the broadcast viewing terminal 200 executes a process (S124), in which if the broadcast viewing terminal 200 reaches the time point for transfer of PPV details (i.e., either a time point a broadcast is completed, a time point a broadcast is initiated, or a specific time point which is set by the CAS 120 of the broadcasting center 100); the broadcast viewing terminal 200 sends the updated PPV details information to the mobile communication network 400 or the Internet 500, which in turn delivers the updated PPV details information to the broadcasting center 100. At this time, sending the PPV details information makes it a rule that a pair, including purchase details and purchase cancellation details, is not sent all together, but only relevant purchase details selected as a transmission list are sent. If purchase details which have already been delivered to the broadcasting center 100 are desired to be canceled, pertinent purchase cancellation details are sent exceptionally.

After that, the broadcasting center 100 executes the charging of price on the basis of the PPV details information provided from the broadcast viewing terminal 200 (S126).

Furthermore, in the case of the occurrence of an obstacle event (e.g., in a case where the broadcast viewing terminal 200 is turned off during the execution of the PPV service, or in a case where providing the PPV service is disabled), before the cancellation of purchase after forming purchase details regarding a prescribed PPV broadcast program, if the purchase details are transferred first, so as to prevent the charging of price regarding the relevant purchase details by the broadcasting center 100 from being executed, corresponding purchase cancellation history is formed, and then the formed purchase cancellation history is sent (S128 to S132)

Also, the transfer of the purchase cancellation history in step S132 is implemented at an available purchase cancellation time by the broadcast viewing terminal 200, or the transfer of the purchase cancellation history in step S132 can be performed through a special access to the mobile communication network 400 of the broadcast viewing terminal 200 or to the internet 500 at a time point excluding the available purchase cancellation time.

The merits and effects of exemplary embodiments, as disclosed in the present invention, and as so configured to operate above, will be described as follows.

According to the present invention, by implementing a method and a system for realizing a series of PPV purchasing mechanisms, including purchase and purchase cancellation regarding each PPV broadcast program, discrimination between an original broadcast and a rebroadcast, and repurchase following the cancellation of purchase, details information formed by purchase and purchase cancellation regarding the PPV broadcasting programs can be flexibly employed, and by discriminating if a PPV broadcast program received through a broadcast viewing terminal is rebroadcasted, setting a discriminative broadcast viewing right and handling the charging of price can be performed.

While the invention has been shown and described with reference to a certain exemplary embodiments thereof, it will be understood by those skilled in the art that various changes in form and details may be made therein without departing from the spirit and scope of the invention. Therefore, the spirit and scope of the present invention must be defined not by described embodiments thereof but by the appended claims and equivalents of the appended claims.

### DRAWING LEGEND INSERTION

### FIG. 1

110: BROADCAST SCHEDULE GENERATOR
130: CW GENERATOR
140: SCRAMBLER
150: ECM GENERATOR
160: EMM GENERATOR
170: CALLBACK SERVER
180: MULTIPLEXER
210: DEMULTIPLEXER
220: DISPLAY
230: DESCRAMBLER
240: SMART CARD
250: MOBILE COMMUNICATION MODEM
260: INTERNET CONNECTION DEVICE
270: CONTROLLER
300: BROADCASTING NETWORK
400: MOBILE COMMUNICATION NETWORK
410: PPV SERVER
500: INTERNET
510: WEB SERVER

PPV [symbol] : PPV BROADCAST PROGRAM

### FIG. 2

S100: SET SYSTEM INFORMATION FOR PPV BROADCAST PROGRAMS
S102: SEND AV STREAM AND SYSTEM INFORMATION THROUGH
BROADCASTING NETWORK
S104: RECEIVE AV STREAM AND SYSTEM INFORMATION
S106: BOOT PURCHASE APPLICATION OF BROADCAST VIEWING TERMINAL
S108: DISPLAY PPV BROADCAST PROGRAM LIST, AND SELECT PURCHASE
S110: IS PURCHASE PERFORMED AT AVAILABLE PURCHASE TIME?
S112: PURCHASE DETAILS?
S114: SET REPURCHASE
S116: FORM PURCHASE DETAILS, AND UPDATE STORED PPV DETAILS INFORMATION
S118: PROCESS BROADCAST VIEWING RIGHT
S120: IS PURCHASE CANCELED AT AVAILABLE PURCHASE CANCELLATION TIME?
S122: FORM PURCHASE CANCELLATION DETAILS, AND UPDATE STORED PURCHASE DETAILS
S124: SEND PURCHASE DETAILS TO MOBILE COMMUNICATION NETWORK OR INTERNET AT SPECIFIC TIME POINT
S126: EXECUTE CHARGING OF PRICE
S128: DOES OBSTACLE EVENT OCCUR?
S130: SEND PURCHASE DETAILS TO MOBILE COMMUNICATION NETWORK OR INTERNET
S132: FORM CORRESPONDING PURCHASE CANCELLATION DETAILS, AND SEND FORMED PURCHASE CANCELLATION DETAILS
[symbol] : START
[symbol] : END

1-22. (canceled)

23. A system for realizing a Pay Per View (PPV) purchasing mechanism, the system comprising:
a broadcasting center for broadcasting PPV broadcast programs and a system information including an available purchase time, an available purchase cancellation time and a time point for transfer of PPV details information regarding each PPV broadcast program;
a broadcast viewing terminal for receiving PPV broadcast programs and the system information from the broadcasting center, for purchasing a PPV broadcast program or canceling the purchase of a PPV broadcast program at the available purchase time or at the available purchase cancellation time, for updating PPV details information updated according to a result of purchasing a PPV broadcast program or canceling the purchase of a PPV broadcast program, and for delivering the updated PPV details information to the broadcasting center,
wherein the broadcast viewing terminal determines whether or not the PPV programs are previously viewed by reading an event IDentification (ID) in which the broadcasting center is programmed to provide as system information in a descriptor of Program Specific Information (PSI) within each PPV broadcast program and comparing the read event ID information with program history included in the PPV details information.

24. The system as claimed in claim 23, wherein the broadcast viewing terminal stores the updated PPV details information in a memory comprising either a Nonvolatile Random Access Memory (NVRAM), a smart card, or a Secure Digital card.

25. The system as claimed in claim 23, wherein the broadcast viewing terminal deliveries the updated PPV details information to the broadcasting center via a mobile communication network,
wherein mobile communication network comprises a PPV server which, being connected to the broadcast viewing terminal through WAP access, is provided with the updated PPV details information from the broadcast viewing terminal, and delivers the updated PPV details information to a callback server of the broadcasting center connected via a network.

26. The system as claimed in claim 23, wherein the broadcast viewing terminal deliveries the updated PPV details information to the broadcasting center via an internet,
wherein the internet comprises a web server, which, being connected to the broadcast viewing terminal through web access, is provided with the updated PPV details information from the broadcast viewing terminal, and delivers the updated PPV details information to the PPV server, or which directly delivers the updated PPV details information to a callback server through web access to the callback server of the broadcasting center.
